(19) United States
(12) Patent Application Publication
(10) Pub. No.: US 2026/0292848 A1
(43) Pub. Date: Sep. 24, 2026

(54) METHODS AND APPARATUS FOR CONFIGURING FIXED FRAME PERIODS IN SIDELINK COMMUNICATION

(71) Applicant: QUALCOMM Incorporated, San Diego, CA (US)

(72) Inventors: Luanxia YANG, Beijing (CN); Changlong XU, Beijing (CN); Jing SUN, San Diego, CA (US); Xiaoxia ZHANG, San Diego, CA (US); Shaozhen GUO, Beijing (CN); Siyi CHEN, Beijing (CN); Hao XU, Beijing (CN)

(21) Appl. No.: 19/100,554

(22) PCT Filed: Sep. 10, 2022
(86) PCT No.: PCT/CN2022/118275

§ 371 Date: Jan. 31, 2025

(51) Int. Cl. H04W 72/25; H04W 72/0446

(52) U.S. Cl. CPC H04W 72/25; H04W 72/0446

(57) ABSTRACT

Aspects of the present disclosure include methods, apparatuses, and computer readable media for receiving an indication of a plurality of resources for sidelink communication between the UE and a neighboring UE, configuring a plurality of fixed frame periods (FFPs) associated with the plurality of resources based on a FFP configuration associated with the UE, transmitting the FFP configuration to the neighboring UE, and transmitting or receiving sidelink information based on at least a portion of the plurality of resources and a portion of the plurality of FFPs.

### BACKGROUND

Aspects of the present disclosure relate generally to wireless communications, and more particularly, to apparatuses and methods for configuring fixed frame periods in sidelink communication.

Wireless communication networks are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which may be referred to as new radio (NR)) is envisaged to expand and support diverse usage scenarios and applications with respect to current mobile network generations. In an aspect, 5G communications technology may include: enhanced mobile broadband addressing human-centric use cases for access to multimedia content, services and data; ultra-reliable-low latency communications (URLLC) with certain specifications for latency and reliability; and massive machine type communications, which may allow a very large number of connected devices and transmission of a relatively low volume of non-delay-sensitive information. As the demand for mobile broadband access continues to increase, however, further improvements in NR communications technology and beyond may be desired.

In a wireless communication network, sidelink communication between two or more user equipment (UE) may be implemented without a base station (BS) relaying the data between the two or more UEs. During sidelink communication, the UEs may operate in load based equipment (LBE) mode or frame based equipment (FBE) mode. When the UE is operating in FBE mode, the sidelink resources may be configured based on a fixed frame period (FFP). However, if the sidelink resources are discontinuous in the time domain, or if there is overlap between the sidelink resources and the FFP idle durations, it may be challenging to configure the FFP properly. Therefore, improvements may be desirable.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Aspects of the present disclosure include methods by a user equipment (UE) for receiving an indication of a plurality of resources for sidelink communication between the UE and a neighboring UE, configuring a plurality of fixed frame periods (FFPs) associated with the plurality of resources based on a FFP configuration associated with the UE, transmitting the FFP configuration to the neighboring UE, and transmitting or receiving sidelink information based on at least a portion of the plurality of resources and a portion of the plurality of FFPs.

Other aspects of the present disclosure include a user equipment (UE) having a memory comprising instructions, a transceiver, and one or more processors operatively coupled with the memory and the transceiver, the one or more processors configured to execute instructions in the memory to receive an indication of a plurality of resources for sidelink communication between the UE and a neighboring UE, configure a plurality of fixed frame periods (FFPs) associated with the plurality of resources based on a FFP configuration associated with the UE, transmit the FFP configuration to the neighboring UE, and transmit or receive sidelink information based on at least a portion of the plurality of resources and a portion of the plurality of FFPs.

An aspect of the present disclosure includes a user equipment (UE) including means for receiving an indication of a plurality of resources for sidelink communication between the UE and a neighboring UE, means for configuring a plurality of fixed frame periods (FFPs) associated with the plurality of resources based on a FFP configuration associated with the UE, means for transmitting the FFP configuration to the neighboring UE, and means for transmitting or receiving sidelink information based on at least a portion of the plurality of resources and a portion of the plurality of FFPs.

Some aspects of the present disclosure include non-transitory computer readable media having instructions stored therein that, when executed by one or more processors of a user equipment (UE), cause the one or more processors to receive an indication of a plurality of resources for sidelink communication between the UE and a neighboring UE, configure a plurality of fixed frame periods (FFPs) associated with the plurality of resources based on a FFP configuration associated with the UE, transmit the FFP configuration to the neighboring UE, and transmit or receive sidelink information based on at least a portion of the plurality of resources and a portion of the plurality of FFPs.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a diagram illustrating an example of a wireless communications system and an access network according to aspects of the present disclosure;

FIG. 2 is a schematic diagram of an example of a user equipment according to aspects of the present disclosure;

FIG. 3 is a schematic diagram of an example of a base station according to aspects of the present disclosure;

FIG. 4 illustrates examples of resource configurations for aligning fixed frame periods according to aspects of the present disclosure;

FIG. 5 illustrates examples of gap symbol configurations according to aspects of the present disclosure;

FIG. 6 illustrates example of per resource pool FFP configuration according to aspects of the present disclosure;

FIG. 7 illustrates an example of resource configuration for addressing overlap between idle duration and PSFCH according to aspects of the present disclosure;

FIG. 8 illustrates examples of PSFCH resource assignments according to aspects of the present disclosure;

FIG. 9 illustrates an example of a first method for configuring FFPs according to aspects of the present disclosure;

FIG. 10 illustrates an example of a second method for configuring FFPs. according to aspects of the present disclosure; and

FIG. 11 illustrates an example of a third method for configuring FFPs according to aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

In some aspects, a user equipment (UE) may directly communicate with other UEs via sidelink channels without a base station (BS) relaying the data between the UE and the other UEs. During sidelink communication, the UEs may operate in load based equipment (LBE) mode or frame based equipment (FBE) mode, where devices content for channel resources during idle durations. Operation in FBE mode may be indicated in remaining minimum system information (RMSI), which may be a scheme for semi-static channel access. When the UE is operating in FBE mode, the sidelink resources may be configured based on a fixed frame period (FFP) having a particular frame duration. The FFP configuration may be included in the system information block 1 (SIB-1). Alternatively, the FFP configuration may also be signaled via UE-specific radio resource control (RRC) signaling.

In one aspect, the FFP may include values of 1 millisecond (ms), 2 ms, 2.5 ms, 4 ms, 5 ms, or 10 ms. The starting positions of the FFPs within every two radio frames may start from an even radio frame, and are given by i*P where I={0, 1, . . . , 20/P-1} where P is the fixed frame period in milliseconds. The idle period for a given subcarrier spacing (SCS) may equal to the ceiling of [Minimum idle period allowed by regulations/Ts] where: 1) the minimum idle period allowed is equal to max(5% of FFP, 100 μs), 2) Ts is the symbol duration for the given SCS, and/or 3) a physical random access channel (PRACH) resource is considered invalid if it overlaps with the IDLE period of a fixed frame period when the FBE operation is indicated.

Aspects of the present disclosure includes schemes for properly configuring sidelink resources when the UE is operating in FBE mode. In some aspects, a FFP may be discarded if the logical slot is not aligned with the starting point of the FFP. In some aspects, the resource configuration of resource pool will be based on the FFP configuration.

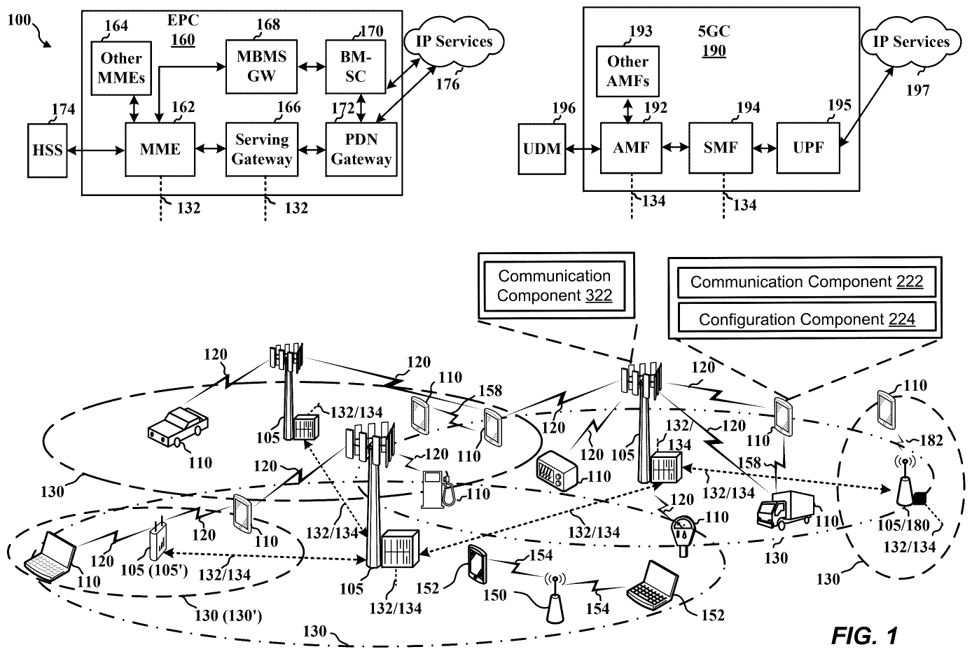

FIG. 1 is a diagram illustrating an example of a wireless communications system and an access network 100. The wireless communications system (also referred to as a wireless wide area network (WWAN)) includes at least one BS 105, UEs 110, an Evolved Packet Core (EPC) 160, and a 5G Core (5GC) 190. The BS 105 may include macro cells (high power cellular base station) and/or small cells (low power cellular base station). The macro cells include base stations. The small cells include femtocells, picocells, and microcells. In one implementation, the UE 110 may include a communication component 222 configured to communicate with the BS 105 via a cellular network, a Wi-Fi network, or other wireless and/or wired networks. The UE 110 may include a configuration component 224 configured to configure FFPs. In some implementations, the communication component 222 and/or the configuration component 224 may be implemented using hardware, software, or a combination of hardware and software. In some implementations, the BS 105 may include a communication component 322 configured to communicate with the UE 110. In some implementations, the communication component 322 may be implemented using hardware, software, or a combination of hardware and software.

A BS 105 configured for 4G Long-Term Evolution (LTE) (collectively referred to as Evolved Universal Mobile Telecommunications System (UMTS) Terrestrial Radio Access Network (E-UTRAN)) may interface with the EPC 160 through backhaul links interfaces 132 (e.g., S1, X2, Internet Protocol (IP), or flex interfaces). A BS 105 configured for 5G NR (collectively referred to as Next Generation RAN (NG-RAN)) may interface with 5GC 190 through backhaul links interfaces 134 (e.g., S1, X2, Internet Protocol (IP), or flex interface). In addition to other functions, the BS 105 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The BS 105 may communicate directly or indirectly (e.g., through the EPC 160 or 5GC 190) with each other over the backhaul links interfaces 134. The backhaul links 132, 134 may be wired or wireless.

The BS 105 may wirelessly communicate with the UEs 110. Each of the BS 105 may provide communication coverage for a respective geographic coverage area 130. There may be overlapping geographic coverage areas 130. For example, the small cell 105′ may have a coverage area 130′ that overlaps the coverage area 130 of one or more macro BS 105. A network that includes both small cell and macro cells may be known as a heterogeneous network. A heterogeneous network may also include Home Evolved Node Bs (eNBs) (HeNBs), which may provide service to a restricted group known as a closed subscriber group (CSG). The communication links 120 between the BS 105 and the UEs 110 may include uplink (UL) (also referred to as reverse link) transmissions from a UE 110 to a BS 105 and/or downlink (DL) (also referred to as forward link) transmissions from a BS 105 to a UE 110. The communication links 120 may use multiple-input and multiple-output (MIMO) antenna technology, including spatial multiplexing, beamforming, and/or transmit diversity. The communication links may be through one or more carriers. The BS 105/UEs 110 may use spectrum up to Y MHz (e.g., 5, 10, 15, 20, 100, 400, etc. MHz) bandwidth per carrier allocated in a carrier aggregation of up to a total of Yₓ MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 110 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 105′ may operate in a licensed and/or an unlicensed frequency spectrum. When operating in an unlicensed frequency spectrum, the small cell 105′ may employ NR and use the same 5 GHz unlicensed frequency spectrum as used by the Wi-Fi AP 150. The small cell 105′, employing NR in an unlicensed frequency spectrum, may boost coverage to and/or increase capacity of the access network.

A BS 105, whether a small cell 105′ or a large cell (e.g., macro base station), may include an eNB, gNodeB (gNB), or other type of base station. Some base stations, such as gNB 180 may operate in one or more frequency bands within the electromagnetic spectrum. The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHZ). The frequencies between FR1 and FR2 are often referred to as mid-band frequencies. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band. Communications using the mmW/near mmW radio frequency band has extremely high path loss and a short range. The mmW base station 180 may utilize beamforming 182 with the UE 110 to compensate for the path loss and short range.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 110 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a packet switched (PS) Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the BS 105 belonging to a Multicast Broadcast Single Frequency Network (MBSFN) area broadcasting a particular service, and may be responsible for session management (start/stop) and for collecting eMBMS related charging information.

The 5GC 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 110 and the 5GC 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The BS 105 may also be referred to as a gNB, Node B, evolved Node B (eNB), an access point, a base transceiver station, a radio base station, an access point, an access node, a radio transceiver, a NodeB, eNodeB (eNB), gNB, Home NodeB, a Home eNodeB, a relay, a transceiver function, a basic service set (BSS), an extended service set (ESS), a transmit reception point (TRP), or some other suitable terminology. The BS 105 provides an access point to the EPC 160 or 5GC 190 for a UE 110. Examples of UEs 110 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 110 may be referred to as IoT devices (e.g., parking meter, gas pump, toaster, vehicles, heart monitor, etc.). The UE 110 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

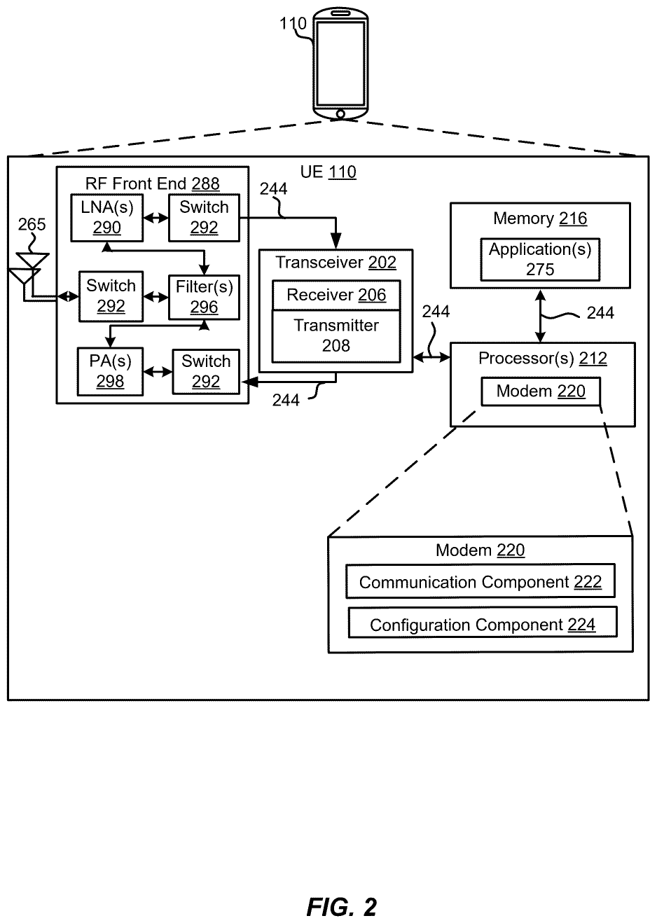

Referring to FIG. 2, one example of an implementation of the UE 110 may include a modem 220 having the communication component 222 and/or the configuration component 224. In one implementation, the UE 110 may include a communication component 222 configured to communicate with the BS 105 via a cellular network, a Wi-Fi network, or other wireless and/or wired networks. The UE 110 may include a configuration component 224 configured to configure FFPs.

In some implementations, the UE 110 may include a variety of components, including components such as one or more processors 212 and memory 216 and transceiver 202 in communication via one or more buses 244, which may operate in conjunction with the modem 220 and the communication component 222 to enable one or more of the functions described herein related to communicating with the BS 105. Further, the one or more processors 212, modem 220, memory 216, transceiver 202, RF front end 288 and one or more antennas 265, may be configured to support voice and/or data calls (simultaneously or non-simultaneously) in one or more radio access technologies. The one or more antennas 265 may include one or more antennas, antenna elements and/or antenna arrays.

In an aspect, the one or more processors 212 may include the modem 220 that uses one or more modem processors. The various functions related to the communication component 222 and/or the configuration component 224 may be included in the modem 220 and/or processors 212 and, in an aspect, may be executed by a single processor, while in other aspects, different ones of the functions may be executed by a combination of two or more different processors. For example, in an aspect, the one or more processors 212 may include any one or any combination of a modem processor, or a baseband processor, or a digital signal processor, or a transmit processor, or a receiving device processor, or a transceiver processor associated with transceiver 202. Additionally, the modem 220 may configure the UE 110 along with the processors 212. In other aspects, some of the features of the one or more processors 212 and/or the modem 220 associated with the communication component 222 may be performed by transceiver 202.

The memory 216 may be configured to store data used and/or local versions of application 275. Also, the memory 216 may be configured to store data used herein and/or local versions of the communication component 222 and/or the configuration component 224, and/or one or more of the subcomponents being executed by at least one processor 212. Memory 216 may include any type of computer-readable medium usable by a computer or at least one processor 212, such as random access memory (RAM), read only memory (ROM), tapes, magnetic discs, optical discs, volatile memory, non-volatile memory, and any combination thereof. In an aspect, for example, memory 216 may be a non-transitory computer-readable storage medium that stores one or more computer-executable codes defining the communication component 222 and/or the configuration component 224, and/or one or more of the subcomponents, and/or data associated therewith, when UE 110 is operating at least one processor 212 to execute the communication component 222 and/or the configuration component 224, and/or one or more of the subcomponents.

Transceiver 202 may include at least one receiver 206 and at least one transmitter 208. Receiver 206 may include hardware, firmware, and/or software code executable by a processor for receiving data, the code comprising instructions and being stored in a memory (e.g., computer-readable medium). Receiver 206 may be, for example, a RF receiving device. In an aspect, the receiver 206 may receive signals transmitted by at least one BS 105. Transmitter 208 may include hardware, firmware, and/or software code executable by a processor for transmitting data, the code comprising instructions and being stored in a memory (e.g., computer-readable medium). A suitable example of transmitter 208 may including, but is not limited to, an RF transmitter.

Moreover, in an aspect, UE 110 may include RF front end 288, which may operate in communication with one or more antennas 265 and transceiver 202 for receiving and transmitting radio transmissions, for example, wireless communications transmitted by at least one BS 105 or wireless transmissions transmitted by UE 110. RF front end 288 may be coupled with one or more antennas 265 and may include one or more low-noise amplifiers (LNAs) 290, one or more switches 292, one or more power amplifiers (PAS) 298, and one or more filters 296 for transmitting and receiving RF signals.

In an aspect, LNA 290 may amplify a received signal at a desired output level. In an aspect, each LNA 290 may have a specified minimum and maximum gain values. In an aspect, RF front end 288 may use one or more switches 292 to select a particular LNA 290 and the specified gain value based on a desired gain value for a particular application.

Further, for example, one or more PA(s) 298 may be used by RF front end 288 to amplify a signal for an RF output at a desired output power level. In an aspect, each PA 298 may have specified minimum and maximum gain values. In an aspect, RF front end 288 may use one or more switches 292 to select a particular PA 298 and the specified gain value based on a desired gain value for a particular application.

Also, for example, one or more filters 296 may be used by RF front end 288 to filter a received signal to obtain an input RF signal. Similarly, in an aspect, for example, a respective filter 296 may be used to filter an output from a respective PA 298 to produce an output signal for transmission. In an aspect, each filter 296 may be coupled with a specific LNA 290 and/or PA 298. In an aspect, RF front end 288 may use one or more switches 292 to select a transmit or receive path using a specified filter 296, LNA 290, and/or PA 298, based on a configuration as specified by transceiver 202 and/or processor 212.

As such, transceiver 202 may be configured to transmit and receive wireless signals through one or more antennas 265 via RF front end 288. In an aspect, transceiver may be tuned to operate at specified frequencies such that UE 110 may communicate with, for example, one or more BS 105 or one or more cells associated with one or more BS 105. In an aspect, for example, the modem 220 may configure transceiver 202 to operate at a specified frequency and power level based on the UE configuration of the UE 110 and the communication protocol used by the modem 220.

In an aspect, the modem 220 may be a multiband-multimode modem, which may process digital data and communicate with transceiver 202 such that the digital data is sent and received using transceiver 202. In an aspect, the modem 220 may be multiband and be configured to support multiple frequency bands for a specific communications protocol. In an aspect, the modem 220 may be multimode and be configured to support multiple operating networks and communications protocols. In an aspect, the modem 220 may control one or more components of UE 110 (e.g., RF front end 288, transceiver 202) to enable transmission and/or reception of signals from the network based on a specified modem configuration. In an aspect, the modem configuration may be based on the mode of the modem and the frequency band in use. In another aspect, the modem configuration may be based on UE configuration information associated with UE 110 as provided by the network.

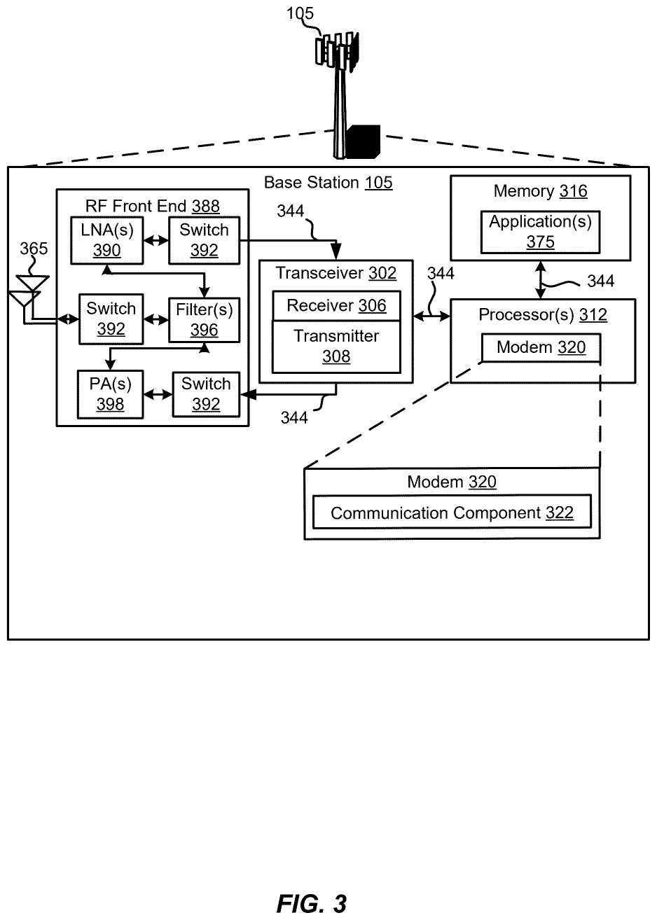

Referring to FIG. 3, one example of an implementation of the BS 105 may include a modem 320 having the communication component 322. In some implementations, the BS 105 may include a communication component 322 configured to communicate with the UE 110.

In some implementations, the BS 105 may include a variety of components, including components such as one or more processors 312 and memory 316 and transceiver 302 in communication via one or more buses 344, which may operate in conjunction with the modem 320 and the communication component 322 to enable one or more of the functions described herein related to communicating with the UE 110. Further, the one or more processors 312, modem 320, memory 316, transceiver 302, RF front end 388 and one or more antennas 365, may be configured to support voice and/or data calls (simultaneously or non-simultaneously) in one or more radio access technologies.

In an aspect, the one or more processors 312 may include the modem 320 that uses one or more modem processors. The various functions related to the communication component 322 may be included in the modem 320 and/or processors 312 and, in an aspect, may be executed by a single processor, while in other aspects, different ones of the functions may be executed by a combination of two or more different processors. For example, in an aspect, the one or more processors 312 may include any one or any combination of a modem processor, or a baseband processor, or a digital signal processor, or a transmit processor, or a receiving device processor, or a transceiver processor associated with transceiver 302. Additionally, the modem 320 may configure the BS 105 and processors 312. In other aspects, some of the features of the one or more processors 312 and/or the modem 320 associated with the communication component 322 may be performed by transceiver 302.

The memory 316 may be configured to store data used herein and/or local versions of applications 375. Also, the memory 316 may be configured to store data used herein and/or local versions of the communication component 322, and/or one or more of the subcomponents being executed by at least one processor 312. Memory 316 may include any type of computer-readable medium usable by a computer or at least one processor 312, such as random access memory (RAM), read only memory (ROM), tapes, magnetic discs, optical discs, volatile memory, non-volatile memory, and any combination thereof. In an aspect, for example, memory 316 may be a non-transitory computer-readable storage medium that stores one or more computer-executable codes defining the communication component 322, and/or one or more of the subcomponents, and/or data associated therewith, when the BS 105 is operating at least one processor 312 to execute the communication component 322, and/or one or more of the subcomponents.

Transceiver 302 may include at least one receiver 306 and at least one transmitter 308. The at least one receiver 306 may include hardware, firmware, and/or software code executable by a processor for receiving data, the code comprising instructions and being stored in a memory (e.g., computer-readable medium). The receiver 306 may be, for example, a RF receiving device. In an aspect, receiver 306 may receive signals transmitted by the UE 110. Transmitter 308 may include hardware, firmware, and/or software code executable by a processor for transmitting data, the code comprising instructions and being stored in a memory (e.g., computer-readable medium). A suitable example of transmitter 308 may including, but is not limited to, an RF transmitter.

Moreover, in an aspect, the BS 105 may include RF front end 388, which may operate in communication with one or more antennas 365 and transceiver 302 for receiving and transmitting radio transmissions, for example, wireless communications transmitted by other BS 105 or wireless transmissions transmitted by UE 110. RF front end 388 may be coupled with one or more antennas 365 and may include one or more low-noise amplifiers (LNAs) 390, one or more switches 392, one or more power amplifiers (PAS) 398, and one or more filters 396 for transmitting and receiving RF signals.

In an aspect, LNA 390 may amplify a received signal at a desired output level. In an aspect, each LNA 390 may have a specified minimum and maximum gain values. In an aspect, RF front end 388 may use one or more switches 392 to select a particular LNA 390 and the specified gain value based on a desired gain value for a particular application.

Further, for example, one or more PA(s) 398 may be used by RF front end 388 to amplify a signal for an RF output at a desired output power level. In an aspect, each PA 398 may have specified minimum and maximum gain values. In an aspect, RF front end 388 may use one or more switches 392 to select a particular PA 398 and the specified gain value based on a desired gain value for a particular application.

Also, for example, one or more filters 396 may be used by RF front end 388 to filter a received signal to obtain an input RF signal. Similarly, in an aspect, for example, a respective filter 396 may be used to filter an output from a respective PA 398 to produce an output signal for transmission. In an aspect, each filter 396 may be coupled with a specific LNA 390 and/or PA 398. In an aspect, RF front end 388 may use one or more switches 392 to select a transmit or receive path using a specified filter 396, LNA 390, and/or PA 398, based on a configuration as specified by transceiver 302 and/or processor 312.

As such, transceiver 302 may be configured to transmit and receive wireless signals through one or more antennas 365 via RF front end 388. In an aspect, transceiver may be tuned to operate at specified frequencies such that BS 105 may communicate with, for example, the UE 110 or one or more cells associated with one or more BS 105. In an aspect, for example, the modem 320 may configure transceiver 302 to operate at a specified frequency and power level based on the base station configuration of the BS 105 and the communication protocol used by the modem 320.

In an aspect, the modem 320 may be a multiband-multimode modem, which may process digital data and communicate with transceiver 302 such that the digital data is sent and received using transceiver 302. In an aspect, the modem 320 may be multiband and be configured to support multiple frequency bands for a specific communications protocol. In an aspect, the modem 320 may be multimode and be configured to support multiple operating networks and communications protocols. In an aspect, the modem 320 may control one or more components of the BS 105 (e.g., RF front end 388, transceiver 302) to enable transmission and/or reception of signals from the network based on a specified modem configuration. In an aspect, the modem configuration may be based on the mode of the modem and the frequency band in use. In another aspect, the modem configuration may be based on base station configuration associated with the BS 105.

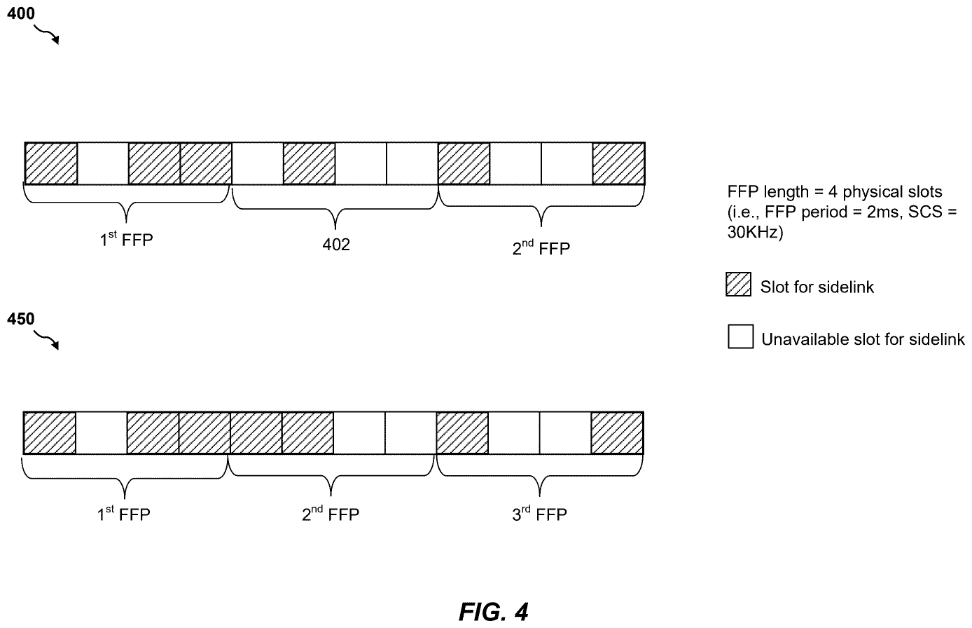

FIG. 4 illustrates examples of resource configurations for aligning fixed frame periods. In some aspects of the present disclosure, a first resource configuration 400 may show a scheme that drops a FFP in response to the starting position of the FFP not aligning with an available resource for sidelink communication (blocks with diagonal line patterns). In the first resource configuration 400 may include FFPs with four physical slots. The starting positions of the first FFP and the second FFP are each aligned with an available resource. The resource slots 402 between the first FFP and the second FFP have an initial resource slot that is unavailable for sidelink communication. As a result, a FFP that would be between the first FFP and the second FFP is discarded according to aspects of the present disclosure.

In some aspects, a second resource configuration 450 may show a scheme where the resource configuration is based on the FFP configuration. In the second resource configuration 450, the FFP configuration may be fixed (e.g., cannot change within 200 milliseconds), and therefore, the resource configuration of the resource pools may align with the FFP configuration.

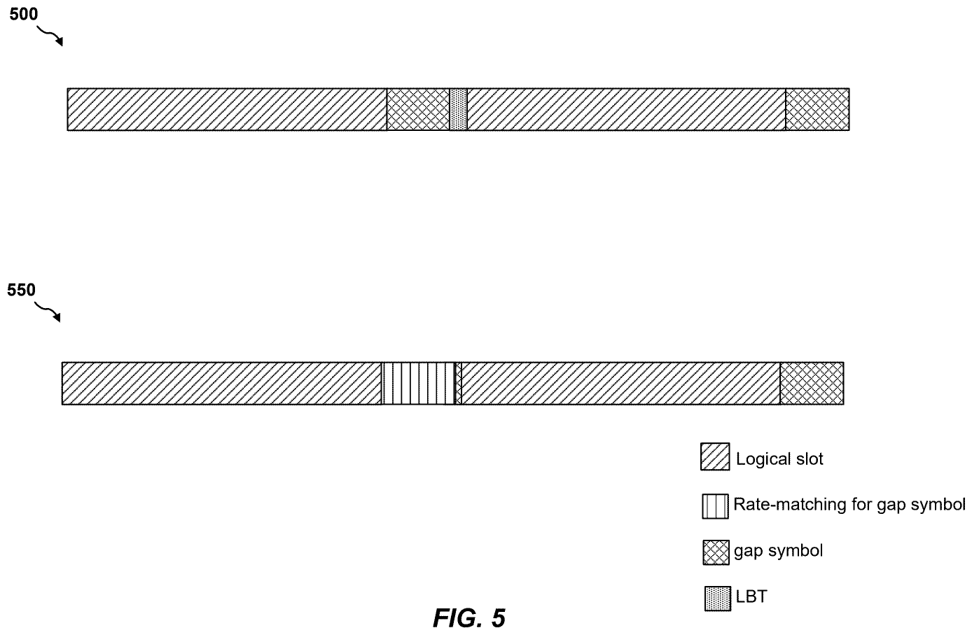

FIG. 5 illustrates examples of gap symbol configurations. In some aspects of the present disclosure, if a FFP includes more than one logical slot, the gap symbol duration with SCS 15 kHz, 30 kHz or 60 kHz may be longer than 16 μs. Aspects of the present disclosure includes schemes to configure the gap symbols. In a first gap symbol configuration 500, the transmitting UE may configure a Category 2 (Cat 2) listen-before-talk LBT before the subsequent logical slot. In certain aspects, a second gap symbol configuration 550 may include the transmitting UE configuring a cyclic prefix (CP) extension within the gap symbol. In some instances, there may be one or more unavailable slots (unavailable for sidelink communication) between two logical slots. The UE may configure a Cat 2 LBT to transmit data and/or control information in the logical slot immediately after the one or more unavailable slots. The Cat 2 LBT may be in the gap symbol between the two logical slots.

An aspect of the present disclosure includes per resource pool FFP configuration. In a first aspect, the idle duration may be fixed at the end of FFP. The UEs in the resource pool may have the same FFP starting point. The collision probability among transmissions may increase. A UE may be not able to share the FFP of other UEs if it fails to contend the channel.

In a second aspect, the FFP may be configured with floated idle, where different UEs may have different starting points of FFP. However, the starting point of the FFP of some UE may not align with the slot boundary. In one aspect, if the starting point is earlier than slot starting point, a CP extension may be used for alignment. The starting point may be located in the gap symbol, and not before the gap symbol. If the starting point is later than the slot starting point, aspects of the present disclosure may configure the network such that the UEs share the same starting symbol. Alternatively, the UEs may have different starting symbols. The UEs may be configured such that the LBT may end before the starting point of the next slot. Certain UEs may have LBT after the starting point of the next slot may employ CP extension.

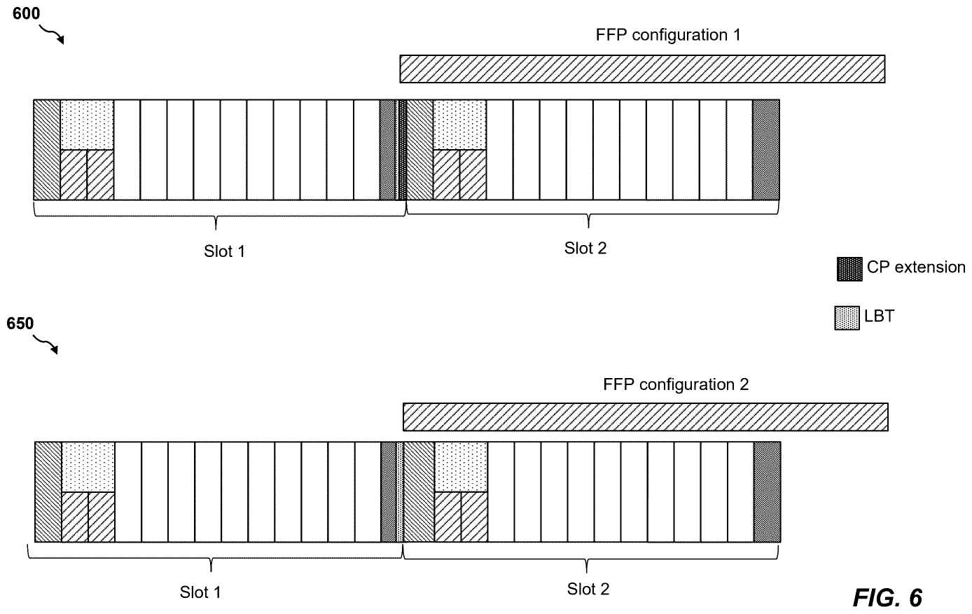

FIG. 6 illustrates example of per resource pool FFP configuration. In a first FFP configuration 600, CP extension may be configured into the resources when the starting point of the FFP is before the slot starting point (of slot 2). In a second FFP configuration 650, LBT may be configured before the starting point of the FFP.

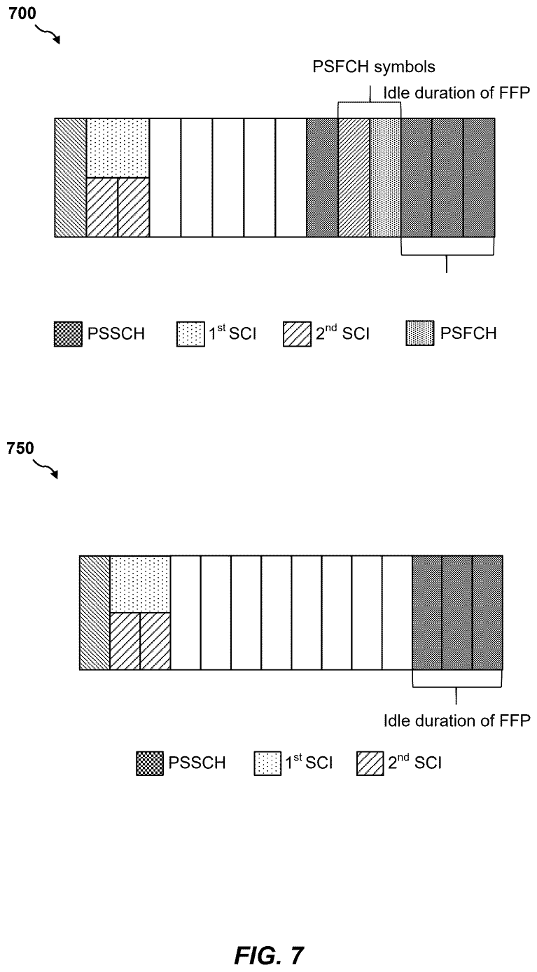

FIG. 7 illustrates an example of resource configuration for addressing overlap between idle duration and PSFCH. In some aspects, a first resource configuration 700 may include an overlap between the idle duration of FFP and physical sidelink feedback channel (PSFCH). During the slot with idle period, if the idle duration occupies X symbols, X may be the maximum occupied symbols of idle for floated idle. The consecutive symbols configured for sidelink may be lengthSLsymbols−X. If PSFCH exists in the slot, the second OFDM symbol of PSFCH transmission in a slot may be startSLsymbols+lengthSLsymbols−1−X. Accordingly, the configuring UE may signal the resource configuration indicated above to neighboring UEs for identifying the locations of the PSFCH.

In some aspects, a second resource configuration 750 may show the resource configuration of physical sidelink shared channel (PSSCH) and the idle duration of FFP. The configuring UE may signal the resource configuration shown in the second resource configuration 750 to the neighboring UEs for identifying the locations of the PSSCH.

As discussed above, some aspects of the present disclosure may include multiple users sharing the same FFP configuration. The traffic of each users may not be aligned. As such, UE specified FFP configuration may be more efficient. However, each UE may have an individual FFP configuration. Different FFP configurations may have different idle durations. Therefore, aspects of the present disclosure may include the transmitting UE signaling the FFP configuration to one or more neighboring UEs dynamically via a field in the sidelink control information 1 (SCI-1) to indicate the available length of the slot. In other aspects, the transmitting UE may signal the individual FFP configuration of the transmitting UE during the initial attach process between the transmitting UE and the one or more neighboring UE. In some aspects, the transmitting UE may indicate, via the SCI-1 field, the length of idle duration. For the slot(s) with idle duration, the consecutive symbols configured for sidelink may be lengthSLsymbols-X, where X is the number of symbols which are occupied by the idle duration.

In certain aspects, the PSFCH may overlap (partially or completely) with the idle duration. In one aspect, the PSFCH may be dropped due to the overlap. In other aspects, the PSFCH resources may be assigned based on the maximum length of the idle duration supported by the resource pool. If the idle duration of the UE exceeds the maximum support length of idle duration, the UE may not be allowed to use the PSFCH resource from the resource pool. In some aspects, the transmitting UE may assign the PSFCH resource instead of the RRC configuration. The transmitting UE may indicate the PSFCH resource by adding a field to the sidelink control information 2 (SCI-2) to indicate the time gap between the SCI-2 and the PSFCH. The transmitting UE may assign the PSFCH resources based on the FFP configurations of the transmitting UE and/or the receiving UE. In some aspects of the present disclosure, the transmitting UE may preconfigure the PSFCH resource during the initial connection between the transmitting UE and the receiving UE. The UE may assign the PSFCH based on the FFP configuration of the UE.

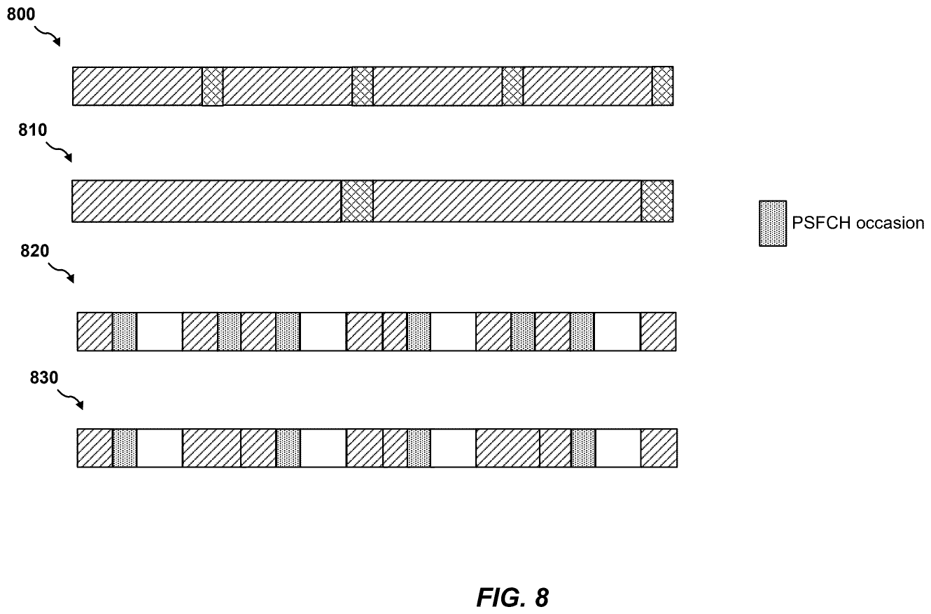

FIG. 8 illustrates examples of PSFCH resource assignments. In some aspects, a first FFP configuration 800 may be the FFP configuration of a transmitting UE. A second FFP configuration 810 may be the FFP configuration of a receiving UE. A first resource assignment 820 may be configured by the transmitting UE in response to the receiving UE signaling the transmitting UE the FFP configuration of the receiving UE shown in the second FFP configuration 810 during the initial connection between the transmitting UE and the receive UE. Specifically, the transmitting UE may configure the PSFCH occasions based on the FFP configuration of the transmitting UE and the FFP configuration of the receive UE signaled by the receiving UE.

In some aspects, a second resource assignment 830 may be configured by the transmitting UE during the initial connection between the transmitting UE and the receiving UE. As such, the transmitting UE may configure the PSFCH occasions based on information indicated during the initial connection, and/or the FFP configuration of the transmitting UE. The information may be up-to-date or stale.

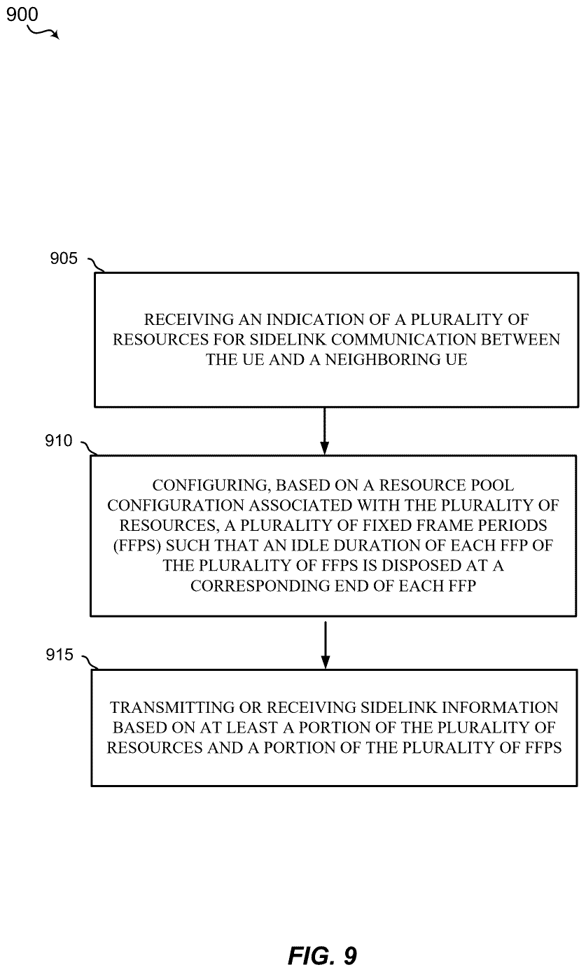

FIG. 9 illustrates an example of a method for configuring FFPs. For example, the method 900 may be performed by the one or more of the processor 212, the memory 216, the applications 275, the modem 220, the transceiver 202, the receiver 206, the transmitter 208, the RF front end 288, the communication component 222, the configuration component 224, and/or one or more other components of the UE 110 in the wireless communication network 100.

At block 905, the method 900 may receive an indication of a plurality of resources for sidelink communication between the UE and a neighboring UE. For example, the one or more of the processor 212, the memory 216, the applications 275, the modem 220, the transceiver 202, the receiver 206, the transmitter 208, the RF front end 288, the communication component 222, and/or one or more other components of the UE 110 may receive an indication of a plurality of resources for sidelink communication between the UE and a neighboring UE.

The one or more of the processor 212, the memory 216, the applications 275, the modem 220, the transceiver 202, the receiver 206, the transmitter 208, the RF front end 288, the communication component 222, and/or one or more other components of the UE 110 may be configured to and/or define means for receiving an indication of a plurality of resources for sidelink communication between the UE and a neighboring UE.

At block 910, the method 900 may configure, based on a resource pool configuration associated with the plurality of resources, a plurality of fixed frame periods (FFPs) such that an idle duration of each FFP of the plurality of FFPs is disposed at a corresponding end of each FFP. For example, the processor 212, the memory 216, the applications 275, the configuration component 224, and/or one or more other components of the UE 110 may configure, based on a resource pool configuration associated with the plurality of resources, a plurality of fixed frame periods (FFPs) such that an idle duration of each FFP of the plurality of FFPs is disposed at a corresponding end of each FFP.

The processor 212, the memory 216, the applications 275, the configuration component 224, and/or one or more other components of the UE 110 may be configured to and/or define means for configuring, based on a resource pool configuration associated with the plurality of resources, a plurality of fixed frame periods (FFPs) such that an idle duration of each FFP of the plurality of FFPs is disposed at a corresponding end of each FFP.

At block 915, the method 900 may transmit or receive sidelink information based on at least a portion of the plurality of resources and a portion of the plurality of FFPs. For example, the one or more of the processor 212, the memory 216, the applications 275, the modem 220, the transceiver 202, the receiver 206, the transmitter 208, the RF front end 288, the communication component 222, and/or one or more other components of the UE 110 may transmit or receive sidelink information based on at least a portion of the plurality of resources and a portion of the plurality of FFPs.

The one or more of the processor 212, the memory 216, the applications 275, the modem 220, the transceiver 202, the receiver 206, the transmitter 208, the RF front end 288, the communication component 222, and/or one or more other components of the UE 110 may be configured to and/or define means for transmitting or receiving sidelink information based on at least a portion of the plurality of resources and a portion of the plurality of FFPs.

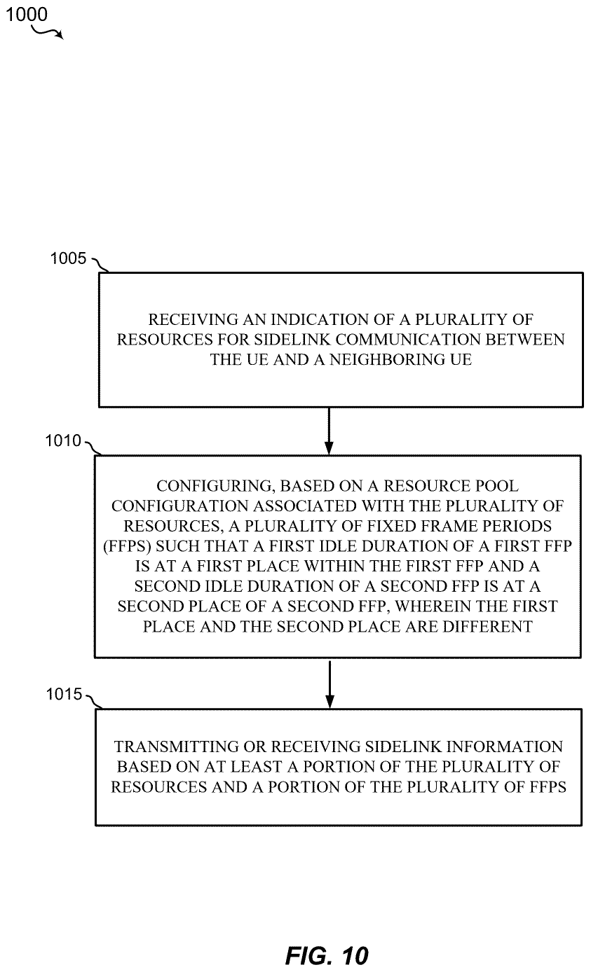

FIG. 10 illustrates an example of a method for configuring FFPs. For example, the method 1000 may be performed by the one or more of the processor 212, the memory 216, the applications 275, the modem 220, the transceiver 202, the receiver 206, the transmitter 208, the RF front end 288, the communication component 222, the configuration component 224, and/or one or more other components of the UE 110 in the wireless communication network 100.

At block 1005, the method 1000 may receive an indication of a plurality of resources for sidelink communication between the UE and a neighboring UE. For example, the one or more of the processor 212, the memory 216, the applications 275, the modem 220, the transceiver 202, the receiver 206, the transmitter 208, the RF front end 288, the communication component 222, and/or one or more other components of the UE 110 may receive an indication of a plurality of resources for sidelink communication between the UE and a neighboring UE.

The one or more of the processor 212, the memory 216, the applications 275, the modem 220, the transceiver 202, the receiver 206, the transmitter 208, the RF front end 288, the communication component 222, and/or one or more other components of the UE 110 may be configured to and/or define means for receiving an indication of a plurality of resources for sidelink communication between the UE and a neighboring UE.

At block 1010, the method 1000 may configure, based on a resource pool configuration associated with the plurality of resources, a plurality of fixed frame periods (FFPs) such that a first idle duration of a first FFP is at a first place within the first FFP and a second idle duration of a second FFP is at a second place of a second FFP, wherein the first place and the second place are different. For example, the processor 212, the memory 216, the applications 275, the configuration component 224, and/or one or more other components of the UE 110 may configure, based on a resource pool configuration associated with the plurality of resources, a plurality of fixed frame periods (FFPs) such that a first idle duration of a first FFP is at a first place within the first FFP and a second idle duration of a second FFP is at a second place of a second FFP, wherein the first place and the second place are different.

The processor 212, the memory 216, the applications 275, the configuration component 224, and/or one or more other components of the UE 110 may be configured to and/or define means for configuring, based on a resource pool configuration associated with the plurality of resources, a plurality of fixed frame periods (FFPs) such that a first idle duration of a first FFP is at a first place within the first FFP and a second idle duration of a second FFP is at a second place of a second FFP, wherein the first place and the second place are different.

At block 1015, the method 1000 may transmit or receive sidelink information based on at least a portion of the plurality of resources and a portion of the plurality of FFPs. For example, the one or more of the processor 212, the memory 216, the applications 275, the modem 220, the transceiver 202, the receiver 206, the transmitter 208, the RF front end 288, the communication component 222, and/or one or more other components of the UE 110 may transmit or receive sidelink information based on at least a portion of the plurality of resources and a portion of the plurality of FFPs.

The one or more of the processor 212, the memory 216, the applications 275, the modem 220, the transceiver 202, the receiver 206, the transmitter 208, the RF front end 288, the communication component 222, and/or one or more other components of the UE 110 may be configured to and/or define means for transmitting or receiving sidelink information based on at least a portion of the plurality of resources and a portion of the plurality of FFPs.

Aspects of the present disclosure includes the method above, further comprising, in response to a starting point of the first FFP being temporally disposed before a slot starting point of the first resource, configuring a cyclic prefix extension before the first resource such that the starting point overlaps with a gap symbol of the first resource.

Aspects of the present disclosure includes any of the methods above, wherein in response to a starting point of the first FFP being temporally disposed after a slot starting point of the first resource, a plurality of UEs share a same starting symbol of the first resource.

Aspects of the present disclosure includes any of the methods above, wherein, in response to a starting point of the first FFP being temporally disposed after a slot starting point of the first resource, each UE of a plurality of UEs is assigned a different starting location of a plurality of starting locations.

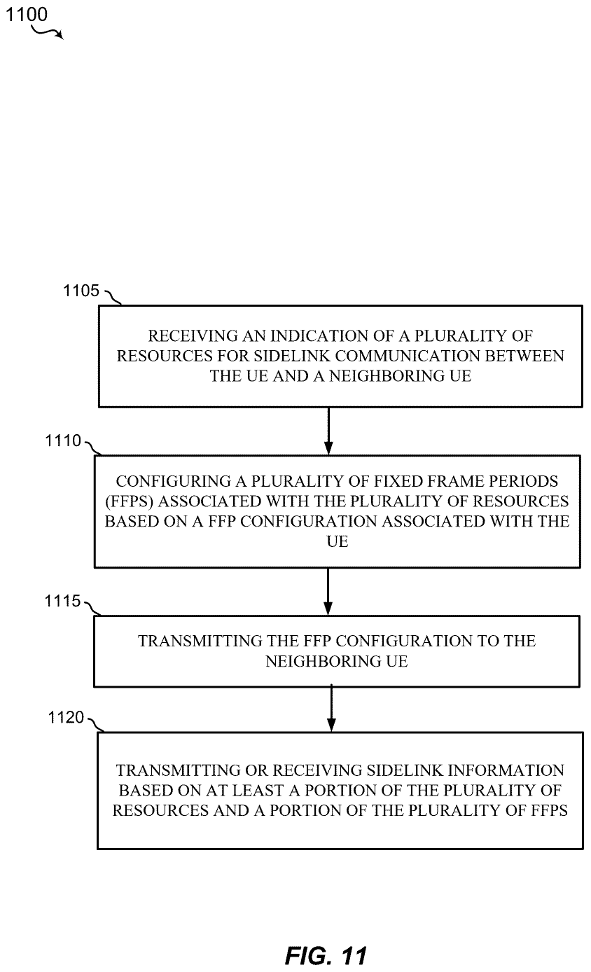

FIG. 11 illustrates an example of a third method for configuring FFPs. For example, a method 1100 may be performed by the one or more of the processor 212, the memory 216, the applications 275, the modem 220, the transceiver 202, the receiver 206, the transmitter 208, the RF front end 288, the communication component 222 and/or the configuration component 224, and/or one or more other components of the UE 110 in the wireless communication network 100.

At block 1105, the method 1100 may receive an indication of a plurality of resources for sidelink communication between the UE and a neighboring UE. For example, the communication component 222, the transceiver 202, the receiver 206, the transmitter 208, the RF front end 288, the subcomponents of the RF front end 288, the processor 212, the memory 216, the modem 220, and/or the applications 275 of the UE 110 may receive an indication of a plurality of resources for sidelink communication between the UE and a neighboring UE as described above. The RF front end 288 may receive the electrical signals converted from electro-magnetic signals. The RF front end 288 may filter and/or amplify the electrical signals. The transceiver 202 or the receiver 206 may convert the electrical signals to digital signals, and send the digital signals to the communication component 222.

In certain implementations, the communication component 222, the transceiver 202, the receiver 206, the transmitter 208, the RF front end 288, the subcomponents of the RF front end 288, the processor 212, the memory 216, the modem 220, and/or the applications 275 may be configured to and/or may define means for receiving an indication of a plurality of resources for sidelink communication between the UE and a neighboring UE.

At block 1110, the method 1100 may configure a plurality of fixed frame periods (FFPs) associated with the plurality of resources based on a FFP configuration associated with the UE. For example, the configuration component 224, the processor 212, the memory 216, the modem 220, and/or the applications 275 of the UE 110 may configure a plurality of fixed frame periods (FFPs) associated with the plurality of resources based on a FFP configuration associated with the UE as described above.

In certain implementations, the configuration component 224, the processor 212, the memory 216, the modem 220, and/or the applications 275 may be configured to and/or may define means for configuring a plurality of fixed frame periods (FFPs) associated with the plurality of resources based on a FFP configuration associated with the UE.

At block 1115, the method 1100 may transmit the FFP configuration to the neighboring UE. For example, the communication component 222, the transceiver 202, the receiver 206, the transmitter 208, the RF front end 288, the subcomponents of the RF front end 288, the processor 212, the memory 216, the modem 220, and/or the applications 275 of the UE 110 may transmit the FFP configuration to the neighboring UE. The communication component 222 may send the digital signals to the transceiver 202 or the transmitter 208. The transceiver 202 or the transmitter 208 may convert the digital signals to electrical signals and send to the RF front end 288. The RF front end 288 may filter and/or amplify the electrical signals. The RF front end 288 may send the electrical signals as electro-magnetic signals via the one or more antennas 265.

In certain implementations, the communication component 222, the transceiver 202, the receiver 206, the transmitter 208, the RF front end 288, the subcomponents of the RF front end 288, the processor 212, the memory 216, the modem 220, and/or the applications 275 may be configured to and/or may define means for transmitting the FFP configuration to the neighboring UE.

At block 1120, the method 1100 may transmit or receive sidelink information based on at least a portion of the plurality of resources and a portion of the plurality of FFPs. For example, the communication component 222, the transceiver 202, the receiver 206, the transmitter 208, the RF front end 288, the subcomponents of the RF front end 288, the processor 212, the memory 216, the modem 220, and/or the applications 275 of the UE 110 may transmit or receive sidelink information based on at least a portion of the plurality of resources and a portion of the plurality of FFPs as described above. The RF front end 288 may receive the electrical signals converted from electro-magnetic signals. During reception, the RF front end 288 may filter and/or amplify the electrical signals. The transceiver 202 or the receiver 206 may convert the electrical signals to digital signals, and send the digital signals to the communication component 222. During transmission, the communication component 222 may send the digital signals to the transceiver 202 or the transmitter 208. The transceiver 202 or the transmitter 208 may convert the digital signals to electrical signals and send to the RF front end 288. The RF front end 288 may filter and/or amplify the electrical signals. The RF front end 288 may send the electrical signals as electro-magnetic signals via the one or more antennas 265.

In certain implementations, the communication component 222, the transceiver 202, the receiver 206, the transmitter 208, the RF front end 288, the subcomponents of the RF front end 288, the processor 212, the memory 216, the modem 220, and/or the applications 275 may be configured to and/or may define means for transmitting or receiving sidelink information based on at least a portion of the plurality of resources and a portion of the plurality of FFPs.

Alternatively or additionally, the method 1100 may further include any of the methods above, wherein transmitting the FFP configuration comprises dynamically transmitting, to the neighbor UE, sidelink control information including a field indicating an available length of at least a slot of the plurality of resources.

Alternatively or additionally, the method 1100 may further include any of the methods above, wherein transmitting the FFP configuration comprises transmitting, to the neighbor UE, the FFP configuration during an initial connection between the UE and the neighboring UE.

Alternatively or additionally, the method 1100 may further include any of the methods above, further comprising identifying an overlap between an idle duration of a FFP and a physical sidelink feedback channel (PSFCH), and refraining from receiving information in the PSFCH.

Alternatively or additionally, the method 1100 may further include any of the methods above, further comprising selecting one or more physical sidelink feedback channel (PSFCH) resources based on a maximum length of an idle duration of a FFP.

Alternatively or additionally, the method 1100 may further include any of the methods above, further comprising transmitting, to the neighbor UE, control information configuring one or more physical sidelink feedback channel (PSFCH) resources.

Alternatively or additionally, the method 1100 may further include any of the methods above, wherein the control information further comprises a field indicating a time gap between the control information and the one or more PSFCH resources.

Alternatively or additionally, the method 1100 may further include any of the methods above, further comprising transmitting, to the neighbor UE, control information preconfiguring one or more physical sidelink feedback channel (PSFCH) resources during an initial connection between the UE and the neighboring UE.

### Additional Implementations

Aspects of the present disclosure include methods by a user equipment (UE) for receiving an indication of a plurality of resources for sidelink communication between the UE and a neighboring UE, configuring a plurality of fixed frame periods (FFPs) associated with the plurality of resources based on a FFP configuration associated with the UE, transmitting the FFP configuration to the neighboring UE, and transmitting or receiving sidelink information based on at least a portion of the plurality of resources and a portion of the plurality of FFPs.
Any of the methods above, wherein transmitting the FFP configuration comprises dynamically transmitting, to the neighbor UE, sidelink control information including a field indicating an available length of at least a slot of the plurality of resources.
Any of the methods above, wherein transmitting the FFP configuration comprises transmitting, to the neighbor UE, the FFP configuration during an initial connection between the UE and the neighboring UE.
Any of the methods above, further comprising identifying an overlap between an idle duration of a FFP and a physical sidelink feedback channel (PSFCH), and refraining from receiving information in the PSFCH.
Any of the methods above, further comprising selecting one or more physical sidelink feedback channel (PSFCH) resources based on a maximum length of an idle duration of a FFP.
Any of the methods above, further comprising transmitting, to the neighbor UE, control information configuring one or more physical sidelink feedback channel (PSFCH) resources.
Any of the methods above, wherein the control information further comprises a field indicating a time gap between the control information and the one or more PSFCH resources.
Any of the methods above, further comprising transmitting, to the neighbor UE, control information preconfiguring one or more physical sidelink feedback channel (PSFCH) resources during an initial connection between the UE and the neighboring UE.

Other aspects of the present disclosure include a user equipment (UE) having a memory comprising instructions, a transceiver, and one or more processors operatively coupled with the memory and the transceiver, the one or more processors configured to execute instructions in the memory to receive an indication of a plurality of resources for sidelink communication between the UE and a neighboring UE, configure a plurality of fixed frame periods (FFPs) associated with the plurality of resources based on a FFP configuration associated with the UE, transmit the FFP configuration to the neighboring UE, and transmit or receive sidelink information based on at least a portion of the plurality of resources and a portion of the plurality of FFPs.
Any of the UEs above, wherein the one or more processors are further configured to dynamically transmit, to the neighbor UE, sidelink control information including a field indicating an available length of at least a slot of the plurality of resources.
Any of the UEs above, wherein the one or more processors are further configured to transmit, to the neighbor UE, the FFP configuration during an initial connection between the UE and the neighboring UE.
Any of the UEs above, wherein the one or more processors are further configured to identify an overlap between an idle duration of a FFP and a physical sidelink feedback channel (PSFCH), and refrain from receiving information in the PSFCH.
Any of the UEs above, wherein the one or more processors are further configured to select one or more physical sidelink feedback channel (PSFCH) resources based on a maximum length of an idle duration of a FFP.
Any of the UEs above, wherein the one or more processors are further configured to transmit, to the neighbor UE, control information configuring one or more physical sidelink feedback channel (PSFCH) resources.
Any of the UEs above, wherein the control information further comprises a field indicating a time gap between the control information and the one or more PSFCH resources.
Any of the UEs above, wherein the one or more processors are further configured to transmit, to the neighbor UE, control information preconfiguring one or more physical sidelink feedback channel (PSFCH) resources during an initial connection between the UE and the neighboring UE.
An aspect of the present disclosure includes a user equipment (UE) including means for receiving an indication of a plurality of resources for sidelink communication between the UE and a neighboring UE, configuring a plurality of fixed frame periods (FFPs) associated with the plurality of resources based on a FFP configuration associated with the UE, transmitting the FFP configuration to the neighboring UE, and transmitting or receiving sidelink information based on at least a portion of the plurality of resources and a portion of the plurality of FFPs.
Any of the UEs above, wherein means for transmitting the FFP configuration comprises dynamically transmitting, to the neighbor UE, sidelink control information including a field indicating an available length of at least a slot of the plurality of resources.
Any of the UEs above, wherein means for transmitting the FFP configuration comprises transmitting, to the neighbor UE, the FFP configuration during an initial connection between the UE and the neighboring UE.
Any of the UEs above, further comprising identifying an overlap between an idle duration of a FFP and a physical sidelink feedback channel (PSFCH), and refraining from receiving information in the PSFCH.
Any of the UEs above, further comprising selecting one or more physical sidelink feedback channel (PSFCH) resources based on a maximum length of an idle duration of a FFP.
Any of the UEs above, further comprising transmitting, to the neighbor UE, control information configuring one or more physical sidelink feedback channel (PSFCH) resources.
Any of the UEs above, wherein the control information further comprises a field indicating a time gap between the control information and the one or more PSFCH resources.
Any of the UEs above, further comprising transmitting, to the neighbor UE, control information preconfiguring one or more physical sidelink feedback channel (PSFCH) resources during an initial connection between the UE and the neighboring UE.
Some aspects of the present disclosure include non-transitory computer readable media having instructions stored therein that, when executed by one or more processors of a user equipment (UE), cause the one or more processors to receive an indication of a plurality of resources for sidelink communication between the UE and a neighboring UE, configure a plurality of fixed frame periods (FFPs) associated with the plurality of resources based on a FFP configuration associated with the UE, transmit the FFP configuration to the neighboring UE, and transmit or receive sidelink information based on at least a portion of the plurality of resources and a portion of the plurality of FFPs.
Any of the non-transitory computer readable media above, wherein the instructions for transmitting the FFP configuration further comprising instructions, when executed by the one or more processors, cause the one or more processors to dynamically transmit, to the neighbor UE, sidelink control information including a field indicating an available length of at least a slot of the plurality of resources.
Any of the non-transitory computer readable media above, wherein the instructions for transmitting the FFP configuration further comprising instructions, when executed by the one or more processors, cause the one or more processors to transmit, to the neighbor UE, the FFP configuration during an initial connection between the UE and the neighboring UE.
Any of the non-transitory computer readable media above, further comprising instructions, when executed by the one or more processors, cause the one or more processors to identify an overlap between an idle duration of a FFP and a physical sidelink feedback channel (PSFCH), and refrain from receiving information in the PSFCH.
Any of the non-transitory computer readable media above, further comprising instructions, when executed by the one or more processors, cause the one or more processors to select one or more physical sidelink feedback channel (PSFCH) resources based on a maximum length of an idle duration of a FFP.
Any of the non-transitory computer readable media above, further comprising instructions, when executed by the one or more processors, cause the one or more processors to transmit, to the neighbor UE, control information configuring one or more physical sidelink feedback channel (PSFCH) resources.
Any of the non-transitory computer readable media above, wherein the control information further comprises a field indicating a time gap between the control information and the one or more PSFCH resources.
Any of the non-transitory computer readable media above, further comprising instructions, when executed by the one or more processors, cause the one or more processors to transmit, to the neighbor UE, control information preconfiguring one or more physical sidelink feedback channel (PSFCH) resources during an initial connection between the UE and the neighboring UE.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. For example, changes may be made in the function and arrangement of elements discussed without departing from the scope of the disclosure. Also, various examples may omit, substitute, or add various procedures or components as appropriate. For instance, the methods described may be performed in an order different from that described, and various steps may be added, omitted, or combined. Also, features described with respect to some examples may be combined in other examples. In some instances, well-known structures and apparatuses are shown in block diagram form in order to avoid obscuring the concepts of the described examples.

It should be noted that the techniques described herein may be used for various wireless communication networks such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA 2000 1X, 1X, etc. IS-856(TIA-856 ) is commonly referred to as CDMA 2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP LTE and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description herein, however, describes an LTE/LTE-A system or 5G system for purposes of example, and LTE terminology is used in much of the description below, although the techniques may be applicable other next generation communication systems.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially-programmed device, such as but not limited to a processor, a digital signal processor (DSP), an ASIC, a FPGA or other programmable logic device, a discrete gate or transistor logic, a discrete hardware component, or any combination thereof designed to perform the functions described herein. A specially-programmed processor may be a microprocessor, but in the alternative, the processor may be any conventional processor, controller, microcontroller, or state machine. A specially-programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above may be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that may be accessed by a general purpose or special purpose computer. By way of example, and not limitation, computer-readable media may comprise RAM, ROM, EEPROM, CD-ROM or other optical disk storage, magnetic disk storage or other magnetic storage devices, or any other medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A method of wireless communication by a user equipment (UE) operating in a frame based equipment (FBE) mode, comprising:
receiving an indication of a plurality of resources for sidelink communication between the UE and a neighboring UE;
configuring a plurality of fixed frame periods (FFPs) associated with the plurality of resources based on a FFP configuration associated with the UE;
transmitting the FFP configuration to the neighboring UE; and
transmitting or receiving sidelink information based on at least a portion of the plurality of resources and a portion of the plurality of FFPs.

2. The method of claim 1, wherein transmitting the FFP configuration comprises:
dynamically transmitting, to the neighbor UE, sidelink control information including a field indicating an available length of at least a slot of the plurality of resources.

3. The method of claim 1, wherein transmitting the FFP configuration comprises:
transmitting, to the neighbor UE, the FFP configuration during an initial connection between the UE and the neighboring UE.

4. The method of claim 1, further comprising:
identifying an overlap between an idle duration of a FFP and a physical sidelink feedback channel (PSFCH); and
refraining from receiving information in the PSFCH.

5. The method of claim 1, further comprising:
selecting one or more physical sidelink feedback channel (PSFCH) resources based on a maximum length of an idle duration of a FFP.

6. The method of claim 1, further comprising:
transmitting, to the neighbor UE, control information configuring one or more physical sidelink feedback channel (PSFCH) resources.

7. The method of claim 6, wherein:
the control information further comprises a field indicating a time gap between the control information and the one or more PSFCH resources.

8. The method of claim 1, further comprising:
transmitting, to the neighbor UE, control information preconfiguring one or more physical sidelink feedback channel (PSFCH) resources during an initial connection between the UE and the neighboring UE.

9. An apparatus for wireless communications at a user equipment (UE), comprising:
a processor
memory coupled with the processor; and
instructions stored in the memory and executable by the processor to cause the apparatus to:
receive an indication of a plurality of resources for sidelink communication between the UE and a neighboring UE;
configure a plurality of fixed frame periods (FFPs) associated with the plurality of resources based on a FFP configuration associated with the UE;
transmit the FFP configuration to the neighboring UE; and
transmit or receive sidelink information based on at least a portion of the plurality of resources and a portion of the plurality of FFPs.

10. The apparatus of claim 9, wherein the one or more processors are further configured to:
dynamically transmit, to the neighbor UE, sidelink control information including a field indicating an available length of at least a slot of the plurality of resources.

11. The apparatus of claim 9, wherein the one or more processors are further configured to:
transmit, to the neighbor UE, the FFP configuration during an initial connection between the UE and the neighboring UE.

12. The apparatus of claim 9, wherein the one or more processors are further configured to:
identify an overlap between an idle duration of a FFP and a physical sidelink feedback channel (PSFCH); and
refrain from receiving information in the PSFCH.

13. The apparatus of claim 9, wherein the one or more processors are further configured to:
select one or more physical sidelink feedback channel (PSFCH) resources based on a maximum length of an idle duration of a FFP.

14. The apparatus of claim 9, wherein the one or more processors are further configured to:
transmit, to the neighbor UE, control information configuring one or more physical sidelink feedback channel (PSFCH) resources.

15. The apparatus of claim 14, wherein:
the control information further comprises a field indicating a time gap between the control information and the one or more PSFCH resources.

16. The apparatus of claim 9, wherein the one or more processors are further configured to:
transmit, to the neighbor UE, control information preconfiguring one or more physical sidelink feedback channel (PSFCH) resources during an initial connection between the UE and the neighboring UE.

17. A non-transitory computer readable medium having instructions stored therein that, when executed by one or more processors of a user equipment (UE), cause the one or more processors to:
receive an indication of a plurality of resources for sidelink communication between the UE and a neighboring UE;
configure a plurality of fixed frame periods (FFPs) associated with the plurality of resources based on a FFP configuration associated with the UE;
transmit the FFP configuration to the neighboring UE; and
transmit or receive sidelink information based on at least a portion of the plurality of resources and a portion of the plurality of FFPs.

18. The non-transitory computer readable medium of claim 17, wherein the instructions for transmitting the FFP configuration further comprising instructions, when executed by the one or more processors, cause the one or more processors to:
dynamically transmit, to the neighbor UE, sidelink control information including a field indicating an available length of at least a slot of the plurality of resources.

19. The non-transitory computer readable medium of claim 17, wherein the instructions for transmitting the FFP configuration further comprising instructions, when executed by the one or more processors, cause the one or more processors to:
transmit, to the neighbor UE, the FFP configuration during an initial connection between the UE and the neighboring UE.

20. The non-transitory computer readable medium of claim 17, further comprising instructions, when executed by the one or more processors, cause the one or more processors to:
identify an overlap between an idle duration of a FFP and a physical sidelink feedback channel (PSFCH); and
refrain from receiving information in the PSFCH.

21. The non-transitory computer readable medium of claim 17, further comprising instructions, when executed by the one or more processors, cause the one or more processors to:
select one or more physical sidelink feedback channel (PSFCH) resources based on a maximum length of an idle duration of a FFP.

22. The non-transitory computer readable medium of claim 17, further comprising instructions, when executed by the one or more processors, cause the one or more processors to:
transmit, to the neighbor UE, control information configuring one or more physical sidelink feedback channel (PSFCH) resources.

23. A user equipment (UE), comprising:
means for receiving an indication of a plurality of resources for sidelink communication between the UE and a neighboring UE;
means for configuring a plurality of fixed frame periods (FFPs) associated with the plurality of resources based on a FFP configuration associated with the UE;
means for transmitting the FFP configuration to the neighboring UE; and
means for transmitting or receiving sidelink information based on at least a portion of the plurality of resources and a portion of the plurality of FFPs.

24. The UE of claim 23, wherein means for transmitting the FFP configuration comprises:
means for dynamically transmitting, to the neighbor UE, sidelink control information including a field indicating an available length of at least a slot of the plurality of resources.

25. The UE of claim 23, wherein means for transmitting the FFP configuration comprises:
means for transmitting, to the neighbor UE, the FFP configuration during an initial connection between the UE and the neighboring UE.

26. The UE of claim 23, further comprising:
means for identifying an overlap between an idle duration of a FFP and a physical sidelink feedback channel (PSFCH); and
refraining from receiving information in the PSFCH.

27. The UE of claim 23, further comprising:
means for selecting one or more physical sidelink feedback channel (PSFCH) resources based on a maximum length of an idle duration of a FFP.

28. The UE of claim 25, further comprising:
means for transmitting, to the neighbor UE, control information configuring one or more physical sidelink feedback channel (PSFCH) resources.

29. The UE of claim 28, wherein:
the control information further comprises a field indicating a time gap between the control information and the one or more PSFCH resources.

30. The UE of claim 23, further comprising:
means for transmitting, to the neighbor UE, control information preconfiguring one or more physical sidelink feedback channel (PSFCH) resources during an initial connection between the UE and the neighboring UE.
